(19) United States
(12) Patent Application Publication
(10) Pub. No.: US 2026/0302985 A1
(43) Pub. Date: Oct. 1, 2026

(54) POWER TOOL INCLUDING FIELD-ORIENTED CONTROL ELECTRONIC CLUTCH

(71) Applicant: MILWAUKEE ELECTRIC TOOL CORPORATION, Brookfield, WI (US)

(72) Inventor: Erik P. Bothe, Pewaukee, WI (US)

(21) Appl. No.: 19/574,933

(22) Filed: Mar. 23, 2026

Related U.S. Application Data
(60) Provisional application No. 63/779,412, filed on Mar. 28, 2025.

(51) Int. Cl. H02P 21/36; B25F 5/00; H02P 21/20; H02P 21/22

(52) U.S. Cl. CPC H02P 21/36; B25F 5/001; H02P 21/20; H02P 21/22; H02P 29/024

(57) ABSTRACT

A power tool includes an electric motor, a first sensor configured to monitor an electrical property of the electric motor and an electronic controller. The electronic controller is configured to determine at least one of a quadrature-axis current and a direct-axis current of the electric motor based on sensor signals from the first sensor, determine a rotational speed of the electric motor, determine an estimated torque output based on (i) at least one of the quadrature-axis current and the direct-axis current and (ii) the rotational speed, and output a command to brake the electric motor in response to the estimated torque output crossing a threshold.

### RELATED APPLICATIONS

This application claims the benefit of U.S. Provisional Patent Application No. 63/779,412, filed Mar. 28, 2025, the entire content of which is hereby incorporated by reference.

### FIELD

The present disclosure relates to power tools and, more particularly, power tools utilizing field-oriented control.

### SUMMARY

Power tools may include torque-limiting mechanisms, such as clutches, that regulate torque output from the power tool, for example, by controlling the torque transmitted from a motor to an output shaft. Implementing torque-limiting mechanisms in power tools may provide various technical benefits. For example, a torque-limiting mechanism may interrupt torque transmission when the torque output reaches or exceeds a predefined threshold. In some examples, such as when the power tool is implemented as a drill/driver, the torque-limiting mechanism may allow a user to apply a specific amount of torque to a fastener. This may help achieve precise tightening in certain applications and/or prevent overtightening, which could otherwise damage the fastener or the material being secured.

Additionally, torque-limiting mechanisms may reduce stress on internal components of the power tool. By interrupting torque transmission before excessive force is applied, these mechanisms may help mitigate wear on gears, bearings, or other load-bearing parts. This reduction in mechanical stress may contribute to improved durability and longevity of the tool.

In some examples, torque-limiting mechanisms are implemented as mechanical clutches. A mechanical clutch may include components such as friction plates, springs, or ball-detent mechanisms that are configured to disengage or slip when the torque transmitted from the motor to the output shaft reaches or exceeds a predefined threshold. While mechanical clutches may provide reliable torque-limiting functionality, they may also present certain technical limitations. For example, repeated engagement and disengagement of mechanical components may lead to wear over time. Additionally, mechanical clutches may have limited precision in controlling the torque threshold, as factors such as friction, spring fatigue, and material properties may introduce variability. Mechanical clutches may also generate noise and vibration during operation, which may negatively impact user experience and tool ergonomics.

To address these technical challenges, electronic clutches may be implemented in power tools. An electronic clutch may estimate the torque output of the motor based on electrical parameters and electronically control the motor to interrupt torque transmission when the estimated torque meets or exceeds a threshold. Compared to mechanical clutches, electronic clutches may offer more precise and consistent torque threshold control, as torque estimation may be dynamically adjusted based on sensor feedback. Additionally, electronic clutches may reduce mechanical wear by eliminating the need for physical engagement components.

Despite these advantages, implementing an electronic clutch may be technically challenging. For example, accurately estimating the torque output of the power tool may be complex because the torque at the motor does not necessarily correspond to the torque at the output shaft. Torque losses may occur due to drivetrain inertia, windage, friction, and other parasitic effects. Since these losses may vary under different operating conditions, estimating them in real time or near-real time may be technically challenging. Additionally, noise and harmonics in sensor signals may affect the accuracy of torque estimation and may utilize filtering techniques to ensure reliable measurements. However, implementing filtering techniques may itself be technically challenging. For example, as phase delays between filtered signals may lead to errors in torque estimation and control feedback.

Systems, apparatuses, methods, and techniques described in this specification provide technical solutions to these and other technical problems by implementing torque estimation models that account for various parasitic loss components, such as inertial effects, windage losses, and friction losses, under different operating conditions. For example, since parasitic losses may behave differently depending on the angular velocity or rotational speed of the motor, the torque estimation model may dynamically adjust for these variations in real time or near-real time. By subtracting dynamically estimated parasitic losses from the estimated motor torque (for example, as determined based on electrical parameters), the system may provide a more accurate estimation of output torque. Additionally, filtering techniques may be implemented to synchronize phase delays between estimated motor torque and motor operating conditions, reducing errors in control feedback.

Furthermore, in various implementations, electronic clutch systems may provide user feedback to indicate when torque transmission is interrupted. For example, motor twitching, haptic feedback, audible alerts, or visual indicators may be used to enhance ergonomics, usability, and control. Thus, these and other techniques described in this specification may improve the accuracy, reliability, and overall user experience of electronic clutches in power tools.

According to some examples, a power tool includes an electric motor, a first sensor configured to monitor an electrical property of the electric motor and an electronic controller. The electronic controller is configured to determine at least one of a quadrature-axis current and a direct-axis current of the electric motor based on sensor signals from the first sensor, determine a rotational speed of the electric motor, determine an estimated torque output based on (i) at least one of the quadrature-axis current and the direct-axis current and (ii) the rotational speed, and output a command to brake the electric motor in response to the estimated torque output crossing a threshold.

In other features, the electronic controller is configured to determine the estimated torque output according to a torque estimation model, the torque estimation model including a motor torque component and a parasitic loss component.

In other features, the electronic controller is configured to determine the estimated torque output by subtracting the parasitic loss component from the motor torque component.

In other features, the electronic controller is configured to determine an estimated motor torque based on the motor torque component, the motor torque component being a function of at least one of the quadrature-axis current and the direct-axis current.

In other features, the electronic controller is further configured to determine the quadrature-axis current and the direct-axis current of the electric motor based on sensor signals from the first sensor and determine an estimated motor torque based on the motor torque component, the motor torque component being a function of the quadrature-axis current and the direct-axis component.

In other features, the electronic controller is configured to determine an estimated parasitic torque loss based on the parasitic loss component, the parasitic loss component being a function of the rotational speed.

In other features, the parasitic loss component includes at least one of an inertial component, a windage component, and a friction component.

In other features, the electronic controller is further configured to determine the rotational speed of the electric motor based on sensor signals from the first sensor.

In other features, the power tool further includes a second sensor configured to monitor a rotational characteristic of the electric motor and the electronic processor is further configured to determine the rotational speed of the electric motor based on sensor signals from the second sensor.

Other examples provide a method that includes determining at least one of a quadrature-axis current and a direct-axis current of an electric motor of a power tool based on sensor signals from a first sensor, the first sensor being configured to monitor an electrical property of the electric motor, determining a rotational speed of the electric motor, determining an estimated torque output based on (i) at least one of the quadrature-axis current and the direct-axis current and (ii) the rotational speed, and outputting a command to brake the electric motor in response to the estimated torque output crossing a threshold.

In other features, the estimated torque output is determined according to a torque estimation model, the torque estimation model including a motor torque component and a parasitic loss component.

In other features, determining the estimated torque output includes subtracting the parasitic loss component from the motor torque component.

In other features, the method includes determining an estimated motor torque based on the motor torque component, the motor torque component being a function of at least one of the quadrature-axis current and the direct-axis current.

In other features, the method includes determining the quadrature-axis current and the direct-axis current of the electric motor based on sensor signals from the first sensor and determining an estimated motor torque based on the motor torque component, the motor torque component being a function of the quadrature-axis current and the direct-axis current.

In other features, the method includes determining an estimated parasitic torque loss based on the parasitic loss component, the parasitic loss component being a function of the rotational speed.

In other features, the parasitic loss component includes at least one of an inertial component, a windage component, and a friction component.

In other features, the rotational speed of the electric motor is determined based on sensor signals from the first sensor.

In other features, the rotational speed of the electric motor is determined based on sensor signals from a second sensor, the second sensor being configured to monitor a rotational characteristic of the electric motor.

Other examples provide a non-transitory computer-readable storage medium that includes executable instructions that, when executed by an electronic processor, causes the electronic processor to determine at least one of a quadrature-axis current and a direct-axis current of an electric motor of a power tool based on sensor signals from a first sensor, the first sensor being configured to monitor an electrical property of the electric motor, determine a rotational speed of the electric motor, determine an estimated torque output based on (i) at least one of the quadrature-axis current and the direct-axis current and (ii) the rotational speed, and output a command to brake the electric motor in response to the estimated torque output crossing a threshold.

In other features, the executable instructions, when executed by the electronic processor, causes the electronic processor to determine the estimated torque output according to a torque estimation model, the torque estimation model including a motor torque component and a parasitic loss component.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other examples, embodiments, features, and aspects will become apparent by consideration of the detailed description and accompanying drawings.

### BRIEF DESCRIPTION OF THE DRAWINGS

FIG. 1 is an isometric view of a power tool, according to some examples.

FIG. 2 is an isometric view of a battery pack, according to some examples.

FIG. 3 is a block diagram illustrating a control system for a power tool, according to some examples.

FIG. 4 is a circuit diagram illustrating a topology of a gate controller and a switching network, according to some examples.

FIG. 5 is a circuit diagram illustrating a current flow path through a switching network, according to some examples.

FIG. 6 is a circuit diagram illustrating a current flow path through a switching network, according to some examples.

FIG. 7 is a circuit diagram illustrating a current flow path through a switching network, according to some examples.

FIG. 8 is a circuit diagram illustrating a current flow path through a switching network, according to some examples.

FIG. 9 is a block diagram illustrating a topology for a controller to implement field-oriented control, according to some examples.

FIG. 10 is a flowchart illustrating a process for controlling a motor, according to some examples.

FIG. 11 is a state diagram illustrating various operational states of a power tool, according to some examples.

FIG. 12 is a flowchart of a process for implementing electronic clutch functionality, according to some examples.

FIG. 13 is a block diagram illustrating components of a torque estimation model, according to some examples.

In the drawings, reference numbers may be reused to identify similar and/or identical elements.

### DETAILED DESCRIPTION

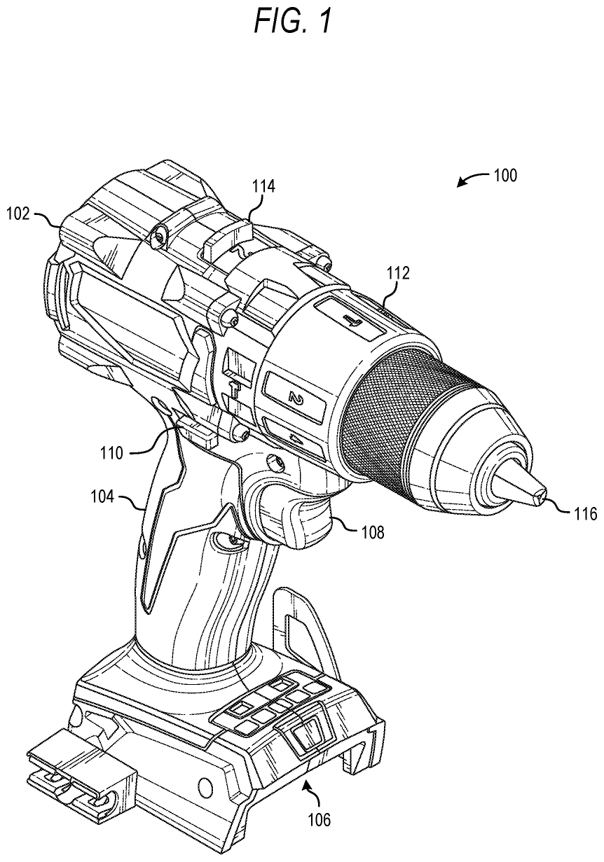

FIG. 1 is an isometric view of a power tool 100, according to some examples. In the example of FIG. 1, the power tool 100 is implemented as a drill/driver. While the power tool 100 is implemented as a drill/driver in the example of FIG. 1, in other examples, the power tool 100 may be implemented as any of a variety of other power tools. In various implementations, the power tool 100 is configured as a drill, a hole shooter, an impact driver, an impact wrench, a hammer drill, or other fastening or drilling tools. In some examples, the power tool 100 is implemented as a cutting or grinding tool, such as a circular saw, a jigsaw, a band saw, an angle grinder, or a straight grinder. In various implementations, the power tool 100 is implemented as a fastening tool, such as, for example, a screwdriver, a powered ratchet, a powered torque wrench, a nailer, a stapler, or a TC bolt gun. In some examples, the power tool 100 is a specialized tool, such as a rotary hammer, an angle drill, a lock bolt installation tool, a reaction arm tool, a riveting tool, or other application-specific power tools. The specific implementation of the power tool 100 may vary depending on the intended application and functional requirements.

In the example of FIG. 1, the power tool 100 includes a main body 102, a handle 104, and a battery pack interface 106. The power tool 100 also includes one or more user inputs, such as, for example, a trigger 108, a forward/reverse selector 110, a torque selector 112, and a range selector 114. In the example of FIG. 1, the trigger 108 is implemented as a sliding variable-position switch that adjusts motor speed based on user actuation. The forward/reverse selector 110 is implemented as a multi-position switch that allows the user to select the rotational direction of the motor. The torque selector 112 is implemented as a multi-position switch or a variable resistance potentiometer that allows the user to adjust torque output across predefined or continuously variable settings. The range selector 114 is implemented as a multi-position switch that allows the user to select different torque ranges for the torque selector 112. In other examples, the user inputs may be implemented using different configurations depending on the application.

The power tool 100 also includes an output element 116. In the example of FIG. 1, the output element 116 is implemented as a bit holder configured to secure a drill or driver bit. In other examples, the output element 116 may be implemented as a socket holder, a collet, a chuck, a blade mount, a grinding wheel interface, or other fastening mechanisms, depending on the type of power tool and its application.

The power tool 100 may include a motor and a controller (not shown in FIG. 1). In various implementations, the motor and the controller are positioned within the main body 102. The controller may receive input from one or more user inputs and adjust motor operation accordingly. For example, actuating the trigger 108 corresponds to selecting a motor speed, while engaging the forward/reverse selector 110 determines the rotational direction. The controller may regulate the motor speed based on the trigger position and maintain the selected direction based on the forward/reverse selector 110.

The user may adjust the torque setting using a combination of the torque selector 112 and the range selector 114. For example, the torque selector 112 allows the user to select a specific torque limit, while the range selector 114 modifies the overall torque range available for selection. For example, the range selector 114 may shift between low-torque and high-torque ranges, allowing the torque selector 112 to adjust within the selected range. The controller can interpret these selections and adjust motor operation accordingly to provide torque output that aligns with the selected settings.

The motor may be mechanically coupled to a drive mechanism (e.g., a transmission), which may then be coupled to the output element 116. The motor transfers mechanical power to the drive mechanism, which, in turn, transfers mechanical power to the output element 116. In various implementations where the power tool 100 is configured as a drill/driver, the drive mechanism may include a series of gears that transmit rotational motion from the motor to the output element 116 while adjusting speed and torque characteristics. For example, the motor may drive a pinion gear that engages with an intermediate gear train or a planetary gear system. These gears may modify the rotational speed and torque before transmitting the mechanical power to the spindle, which rotates the output element 116.

As will be described in detail, the controller may implement electronic clutch functionality. For example, the controller may set a torque threshold based on a combination of user inputs via the torque selector 112 and the range selector 114. The controller may estimate the torque output via the output element 116. In response to the estimated torque output exceeding the threshold, the controller can brake the motor, interrupting the torque transmitted from the motor to the output element 116.

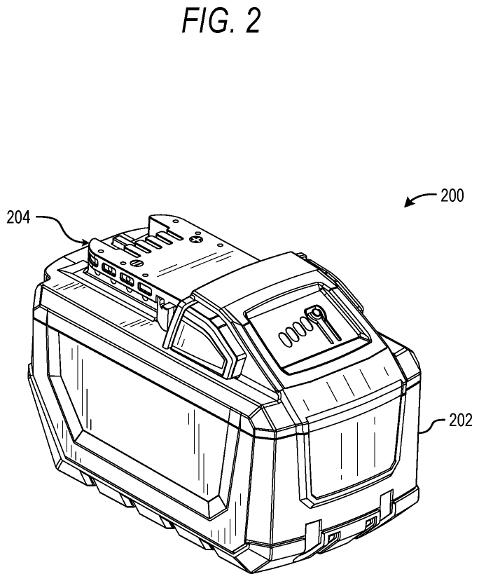

FIG. 2 is an isometric view of a battery pack 200, according to some examples. The battery pack 200 may be a power tool battery pack configured to supply power to a power tool, such as the power tool 100. In the example of FIG. 2, the battery pack 200 includes a housing 202 and an interface portion 204 for connecting the battery pack 200 to the power tool 100. The battery pack 200 may include one or more battery cells contained within the housing 202. For example, the battery pack 200 includes lithium-ion battery cells. In other implementations, the battery pack 200 may include cells with a different chemistry, such as nickel-cadmium, nickel-metal hydride, or other rechargeable battery technologies.

In the example of FIG. 2, the battery pack 200 is an 18-volt battery pack. In other implementations, the battery pack 200 may have a different nominal voltage. For example, the battery pack 200 may be configured as a 4-volt, 28-volt, 36-volt, 72-volt, 96-volt, or 120-volt battery pack, or another voltage level based on the power tool's design requirements. The battery pack 200 may also have different energy storage capacities, such as 3, 4, 5, 6, 8, or 12 ampere-hours, depending on the number and type of battery cells used.

The interface portion 204 may include elements for removably and securely connecting the battery pack 200 to the power tool 100 and/or facilitating electrical and data communication between the battery pack 200 and the power tool 100. In various implementations, the interface portion 204 may include mechanical features such as latches, rails, or locking tabs that engage with corresponding features at the battery pack interface 106 of the power tool 100. These mechanical features may help align the battery pack 200 with the battery pack interface 106 and provide a secure attachment during operation.

The interface portion 204 may also include electrical terminals that provide power to the power tool 100. In some examples, these terminals include a positive and a negative terminal that connect to corresponding terminals at the battery pack interface 106 to deliver electrical power from the battery pack 200 to the power tool 100. In various implementations, the interface portion 204 may also include data terminals for communication between the battery pack 200 and the power tool 100. For example, the battery pack 200 may include a microcontroller that monitors characteristics, such as voltage, current, temperature, or capacity. The data terminals may facilitate communication of this information to the power tool 100, allowing the tool's controller to adjust operation based on battery status.

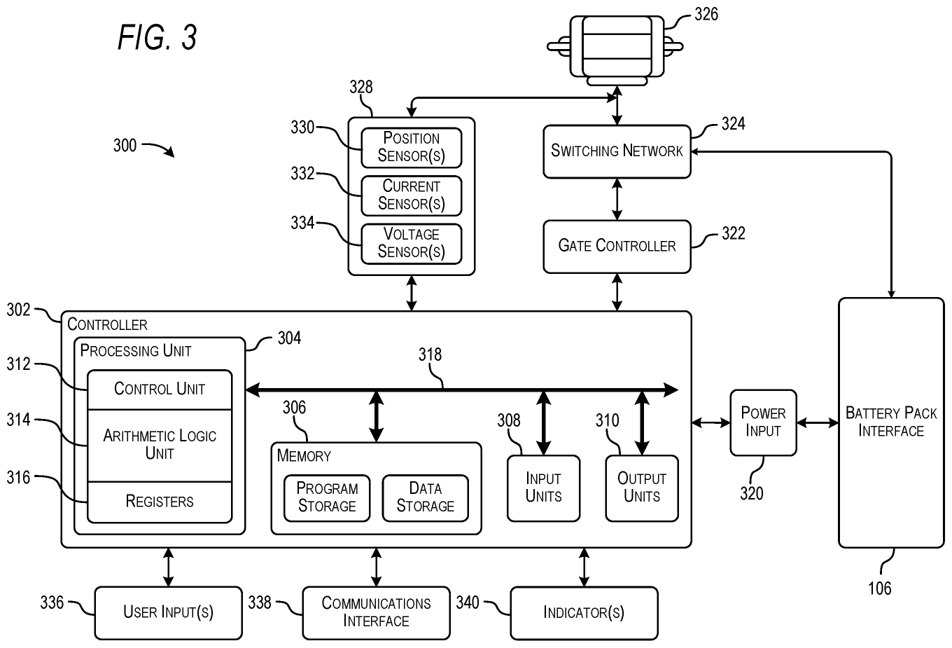

FIG. 3 is a block diagram illustrating a control system 300 for the power tool 100, according to some examples. In various implementations, portions of the control system 300 can be integrated into or connected to a printed circuit board (PCB) and can include an electronic controller 302. The electronic controller 302 may include hardware and/or software designed to manage the operation of various components the power tool 100. The electronic controller 302 may include various electrical and/or electronic components that provide power, operational control, and/or protection to the components and/or modules within the electronic controller 302 and/or the power tool 100. For example, the electronic controller 302 includes a processing unit 304 (such as a microprocessor, a microcontroller, an electronic processor, an electronic controller, or other suitable programmable devices), a memory 306, input units 308, and/or output units 310. The processing unit 304 may include components such as a control unit 312, an arithmetic logic unit (ALU) 314, and/or a set of registers 316 (depicted in FIG. 3 as a group of registers). The processing unit 304 may use computer architectures such as a modified Harvard architecture, a von Neumann architecture, or other suitable architectures.

The processing unit 304, memory 306, input units 308, output units 310, and/or other modules connected to the electronic controller 302 may be interconnected via one or more control and/or data buses such as a common bus 318. While these buses are shown generally in FIG. 3 for illustrative purposes, the use of one or more control and/or data buses for the interconnection between and communication among the various modules and/or components would be known to a person skilled in the art in view of the embodiments described herein.

The memory 306 is a non-transitory computer-readable medium that includes, for example, a program storage area and/or a data storage area. The program storage area and data storage area can include any combination of different types of memory, such as read-only memory (ROM), random access memory (RAM), such as, for example, dynamic RAM (DRAM), synchronous DRAM (SDRAM), etc., electrically erasable programmable read-only memory (EEPROM), flash memory, one or more hard drives, one or more SD cards, and/or other suitable magnetic, optical, physical, and/or electronic memory devices. The processing unit 304 is connected to the memory 306 and is configured to execute software instructions that are capable of being stored in a RAM of the memory 306 (such as during execution), a ROM of the memory 306 (such as on a generally permanent basis), and/or another non-transitory computer-readable medium such as another memory or a disc.

The software stored in memory 306 may control various functions of the power tool 100. For example, the functional blocks, flowchart elements, and technical explanations described herein may serve as software specifications, which have been translated into the computer programs. This software may include firmware, applications, program data, filters, rules, program modules, and/or other executable instructions. The electronic controller 302 may retrieve and execute these instructions to control the operation of the power tool 100. In other configurations, the electronic controller 302 may include additional, fewer, and/or different components depending on the specific implementation.

The electronic controller 302 may be electrically and/or communicatively connected to and/or control operation of various modules and/or components of the power tool 100. In the example of FIG. 3, the power tool 100 includes a power input module 320, which regulates and manages the electrical power delivered from the battery pack interface 106 to the electronic controller 302 and other components of the power tool 100. For example, the power input module 320 receives direct current (DC) power from the battery pack 200 via the electrical terminals. The power input module 320 may include a combination of active and passive components, such as voltage regulators, current limiters, capacitors, and/or filtering circuits that adjust the voltage to appropriate levels required by the electronic controller 302 and/or other components. In various implementations, the power input module 320 filters noise from the DC power before providing the filtered power to the electronic controller 302 and/or other components.

In the example of FIG. 3, the power tool 100 includes a gate controller 322 and an switching network 324 for driving a motor 326 (such as the motor previously described with reference to FIG. 1). The motor 326 includes a rotor, a stator, and a shaft. The stator is the stationary part of the motor 326 and include coils of wire (which may be referred to as windings) through which current flows, creating a rotating magnetic field. The rotor may be positioned within or around the stator and is the moving part that rotates when acted upon by the magnetic field generated by the stator. The rotor may be connected to a shaft, which rotates about a longitudinal axis, transmitting the mechanical force generated by the motor 326 to the drive mechanism.

The motor 326 may be electrically connected to and receive power from the switching network 324. The switching network 324 may receive direct current (DC) from the battery pack 200 via the battery pack interface 106 and may convert the DC into phase signals. The phase signals may be applied to the stator windings in a controlled sequence, creating the magnetic fields that drive the rotor's rotation. For example, the gate controller 322 may be electrically connected to the switching network 324 and regulate the operation of switches (such as field-effect transistors [FETs]) within the switching network 324, determining when and how the DC power is converted into phase signals. The electronic controller 302 may be electrically connected to and generate and send control signals to the gate controller 322, instructing the gate controller 322 how to manage the operation of the switches of the switching network 324. Managing the timing and modulation of the switches of the switching network 324 allows for precise adjustments to frequency an amplitude of the power supplied to the motor 326, which allows for precise control of the speed, torque, and direction of the motor 326.

In various implementations, the power tool 100 implements advanced control techniques such as field-oriented control to precisely manage performance of the motor 326. Field-oriented control allows for independent control of torque and magnetic flux by mathematically transforming the three-phase current signals into a rotating reference frame aligned with the rotor's magnetic field. This provides superior dynamic response and efficiency compared to other control methods. As part of this control strategy, the power tool 100 can also implement field weakening to facilitate operation of the motor 326 beyond its base speed under various operating conditions. Field weakening is implemented to achieve higher output speeds at the motor 326 by reducing the strength of the magnetic field generated by the stator. This is accomplished by adjusting the phase signals applied to the stator windings, for example, by applying a negative d-axis current to reduce the stator's magnetic field strength, thereby reducing back-EMF and allowing for higher speeds.

The electronic controller 302 may implement field-oriented control (FOC) to regulate the operation of the motor 326 by independently controlling the torque-producing and magnetizing components of the stator current. In various implementations, the electronic controller 302 may transform motor phase currents into a rotating reference frame, where the direct-axis (d-axis) component regulates the magnetizing flux linkage, and the quadrature-axis (q-axis) component determines the torque output of the motor 326. By dynamically adjusting these current components, the electronic controller 302 may optimize motor performance across different operating conditions.

For example, the electronic controller 302 may send control signals to the gate controller 322, which adjusts the phase signals output from the switching network 324 to implement field weakening by dynamically altering the current applied to the stator windings of the motor 326. During high-speed operation, the electronic controller 302 may command the gate controller 322 to reduce the d-axis current while increasing the rotor's rotational speed. This reduces the magnetic flux in the motor 326, which limits the back electromotive force (EMF) induced in the stator windings, allowing the motor 326 to operate at higher speeds without exceeding voltage limits of the battery pack 200 or the switching network 324. Additional details related to field-oriented control will be described herein.

In various implementations, the power tool 100 includes one or more sensors 328 that provide feedback to the electronic controller 302 for motor control and system monitoring. These sensors 328 may include position sensors 330, current sensors 332, and/or voltage sensors 334, which may provide data for implementing field-oriented control. The electronic controller 302 may receive sensor signals from these sensors to regulate operation of the motor 326, optimize efficiency, and protect system components.

In various implementations, the sensors 328 (including, for example, current sensors 332 and voltage sensors 334) may be configured to monitor one or more electrical parameters and/or electrical properties of the motor 326. Such electrical parameters or electrical properties may include, for example, current, voltage, back electromotive force (EMF), power, or other electrical characteristics associated with operation of the motor 326.

For example, position sensors 330 may detect the rotor's angular position and speed, allowing the electronic controller 302 to synchronize the phase currents with the rotor's magnetic field. In various implementations, position sensors 330 include encoders, resolvers, or Hall-effect sensors that measure the rotor position directly. Alternatively, sensorless estimation techniques may be used, where the controller 302 infers rotor position based on back EMF or motor current feedback.

Current sensors 332 may measure the electrical current supplied to the stator windings of the motor 326. These measurements allow the electronic controller 302 to determine the d-axis and q-axis components of the motor current in a transformed reference frame. By regulating the d-axis and q-axis current components based on measured values, the electronic controller 302 may regulate torque and magnetic flux independently. In various implementations, current sensors 332 include shunt resistors, Hall-effect current sensors, or fluxgate sensors placed in the motor drive circuit to monitor phase currents.

Voltage sensors 334 may track the voltage supplied by the battery pack 200 and/or the voltage across the terminals of the motor 326. These measurements allow the electronic controller 302 to adjust control strategies, such as field weakening, when operating at high speeds. For example, by monitoring back EMF and DC bus voltage, the controller may ensure that voltage limits of the battery pack 200 and the switching network 324 are not exceeded. Voltage sensors 334 may include resistive voltage dividers, isolation amplifiers, or other voltage-sensing circuits.

The sensors 328 may include additional sensors for broader system monitoring and control. In some examples, the sensors 328 may include temperature sensors to monitor the motor 326 or switching network 324, torque sensors to measure the torque output at the motor shaft, acceleration sensors to detect rapid speed or direction changes, and vibration sensors to monitor excessive vibrations that could indicate mechanical wear or imbalance. Other examples of sensors 328 include proximity sensors, strain gauges, optical sensors, and gyroscopic sensors, depending on the application and design requirements of the power tool 100.

The electronic controller 302 may be electrically connected to one or more user inputs 336. The user inputs 336 may include the trigger 108, the forward/reverse selector 110, a torque selector 112, and/or the range selector 114, and/or any combination of digital and/or analog devices, including knobs, dials, switches, buttons, touchscreens, etc. In various implementations, the controller 302 detects user interactions with the user input 336 and changes an operating parameter of the motor 326 (such as starting the motor, stopping the motor, adjusting the speed of the motor, adjusting the torque output by the motor, adjusting the torque threshold of the electronic clutch, switching the direction of rotation of the motor, etc.).

In some examples, the power tool 100 includes a communications interface 338, such as a Bluetooth, Wi-Fi, and/or other wireless communication module. The communications interface 338 allows the electronic controller 302 to receive wireless signals from external devices (such as smartphones, tablets, or other control systems, etc.) and control various operational aspects of the power tool 100 accordingly.

In various implementations, the power tool 100 includes one or more indicators 340. The indicators 340 may include various types of display elements, such as light-emitting diodes (LEDs), display screens, or other types of visual or audible indicators. The indicators 340 may be electrically connected to the electronic controller 302, and the electronic controller 302 may control the indicators to output operational statuses of the power tool 100 to the user (such as, for example, indications of motor running, motor idle, battery pack state of charge, low battery warning, charging status, fault detection, motor overload, over-temperature warning, mode selection [e.g., forward/reverse], torque setting, and/or maintenance or service alerts, etc.).

In various implementations, the power tool 100 includes one or more indicators 340 that provide audio, visual, and haptic feedback to communicate operational statuses to the user. These indicators 340 may be electrically connected to the electronic controller 302, which may control them based on real-time tool conditions. Audio indicators may include speakers or buzzers that generate tones, beeps, or voice alerts. Visual indicators may include light-emitting diodes (LEDs) or display screens that present status information through illuminated signals, icons, or text. Haptic indicators may include haptic engines that generate vibrations to provide tactile feedback.

The indicators 340 may output operational statuses of the power tool 100. For example speakers may emit beeps or spoken messages to indicate warnings, confirmations, or tool settings. LEDs may illuminate, flash, or change color to represent different states, while display screens may show numerical values, graphical icons, or system messages. Haptic engines may provide brief or sustained vibrations to signal specific tool conditions. The indicators 340 may communicate a variety of statuses, such as motor running, motor idle, battery pack state of charge, low battery warning, charging status, fault detection, motor overload, over-temperature warning, mode selection (e.g., forward/reverse), torque setting, and maintenance or service alerts. In various implementations, the indicators 340 provide feedback related to the electronic clutch. For example, when the torque limit is reached, the haptic engine may generate a vibration, the speaker may emit an alert tone, and the LED or display screen may signal that torque transmission has been interrupted.

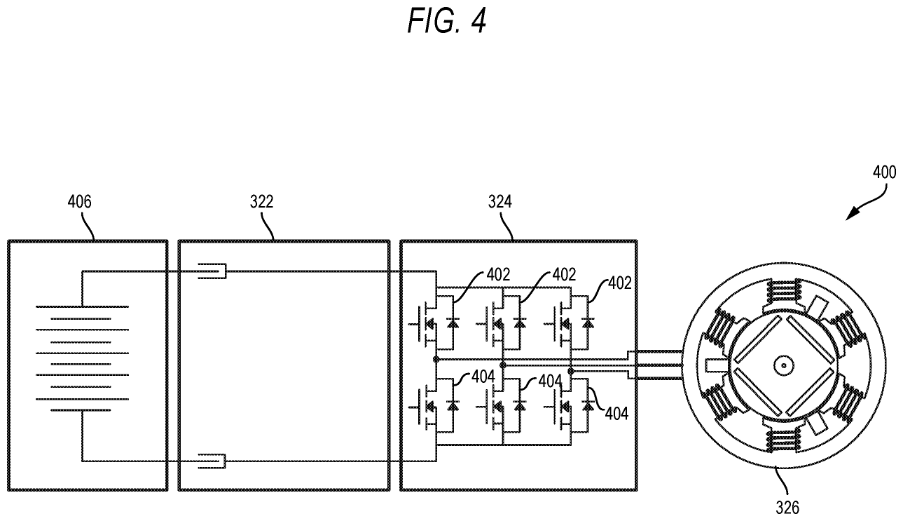

FIG. 4 is a circuit diagram 400 illustrating the topology of the gate controller 322 and the switching network 324, according to some examples. The switching network 324 includes one or more high-side switching elements 402 and one or more low-side switching elements 404. In various implementations, the high-side power switching elements 402 and the low-side power switching elements 404 are implemented using field-effect transistors (FETs) such as MOSFETs (metal-oxide-semiconductor FETs) or IGBTs (insulated-gate bipolar transistors).

The electronic controller 302 may command the gate controller 322 to provide control signals that selectively activate and deactivate the high-side and low-side switching elements 402 and 404. In response to detecting activation of the trigger 108, the electronic controller 302 may initiate a sequence in which power from the power source 406 (e.g., the battery pack 200) is applied to the stator windings of the motor 326 in a controlled manner.

For example, the electronic controller 302 may determine rotor position based on pulse signals from the sensors 328 and command the gate controller 322 to sequentially activate pairs of high-side and low-side switching elements 402 and 404. This switching sequence generates a rotating magnetic field in the stator, which interacts with the rotor to induce motion. As the rotor advances, the controller 302 continues updating switching signals based on sensor feedback, ensuring that commutation remains aligned with the rotor's position.

To regulate motor speed and torque, the electronic controller 302 may adjust the pulse width modulation (PWM) duty cycle of the switching signals. In various implementations, the duty cycle may be proportional to the trigger pull of the trigger 108, allowing for fine control over the power delivered to the motor 326.

Sensor feedback may also support field-oriented control (FOC), allowing the electronic controller 302 to independently regulate torque-producing and magnetizing current components. Current sensors 332 may measure stator phase currents, which the controller 302 may transform into a rotating reference frame to separate them into direct-axis current (i_{d}) and quadrature-axis current (i_{q}). The i_{d} component controls the magnetizing flux linkage, while the i_{q} component governs torque production. By regulating i_{d} and i_{q} components, the controller 302 may extend the speed range of the motor 326 under varying operating conditions.

For example, during high-speed operation, the electronic controller 302 may implement field weakening by reducing i_{d}, which decreases the overall magnetic flux linkage and helps limit back EMF. This reduction in flux lowers the back EMF, allowing the motor 326 to operate at higher speeds without exceeding voltage constraints imposed by the battery pack 200 and the switching network 324. Simultaneously, the controller 302 may adjust i_{q} to regulate torque output, ensuring stable performance while maintaining efficient power usage.

The number, type, and arrangement of the high-side switching elements 402 and low-side switching elements 404 may vary depending on the application and power requirements of the power tool 100. Alternative configurations may incorporate different switching topologies or additional protective components to enhance efficiency and reliability.

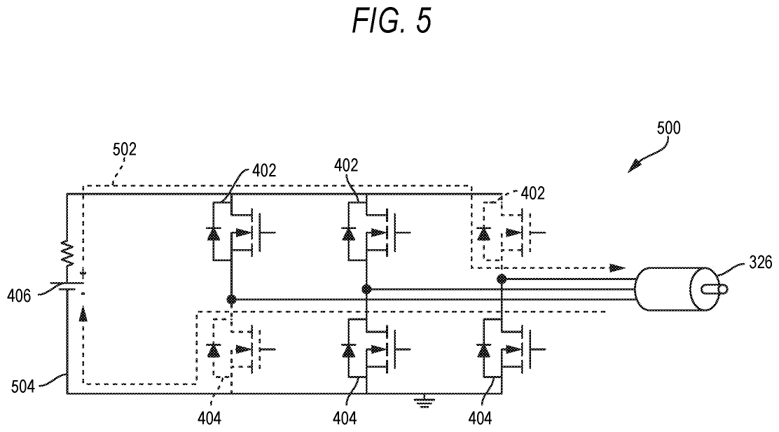

FIG. 5 is a circuit diagram 500 illustrating a current flow path through the switching network 324, according to some examples. The switching network 324 may include one or more high-side switching elements 402 and one or more low-side switching elements 404, as described above. For example, in response to detecting a pull of the trigger 108, the controller 302 may command the gate controller 322 to provide one or more control signals that selectively activate and deactivate the high-side switching elements 402 and the low-side switching elements 404 (e.g., sequentially, in pairs). This switching sequence may result in power being supplied from the power source 406.

In various implementations, current 502 may flow from the power source 406 through one of the high-side switching elements 402 to stator coils of the motor 326. The current 502 may then flow from the motor 326 to one of the low-side switching elements 404 before completing a conductive path 504 to the power source 406. The specific current flow path and switching sequence may vary based on factors such as motor position, load conditions, and control strategy.

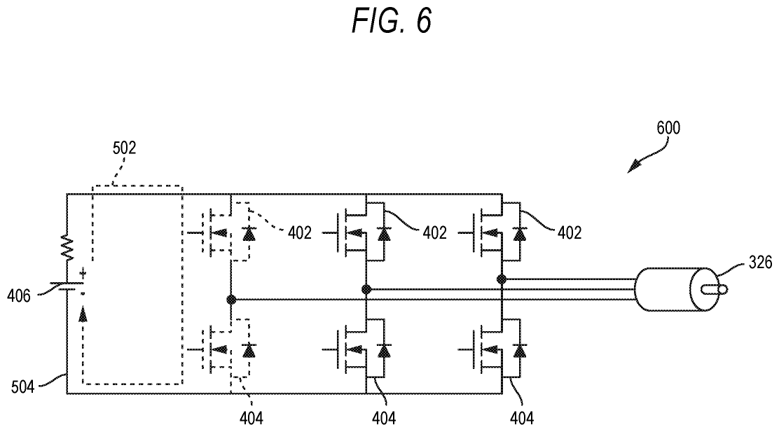

FIG. 6 is a circuit diagram 600 illustrating a current flow path through the switching network 324, according to some examples. The switching network 324 may include one or more high-side switching elements 402 and one or more low-side switching elements 404, as described above. For example, in response to detecting a pull of the trigger 108, the controller 302 may command the gate controller 322 to provide one or more control signals that selectively activate and deactivate the high-side switching elements 402 and the low-side switching elements 404 (e.g., sequentially, in pairs). This switching sequence may result in power being supplied from the power source 406.

In various implementations, current 502 may flow from the power source 406 through one of the high-side switching elements 402 to one of the low-side switching elements 404. The current 502 may then return to the power source 406, completing the circuit. Compared to other switching configurations, this current path may involve only two switching elements and may result in a shorter conductive path 504 through the switching network 324.

In some examples, multiple high-side switching elements 402 and/or multiple low-side switching elements 404 may be activated at the same time. This control approach may reduce overall system resistance, allowing for higher current flow while distributing the electrical load across multiple switching elements. Distributing the load in this manner may help manage thermal dissipation and reduce the likelihood of excessive heating or wear in individual switching elements.

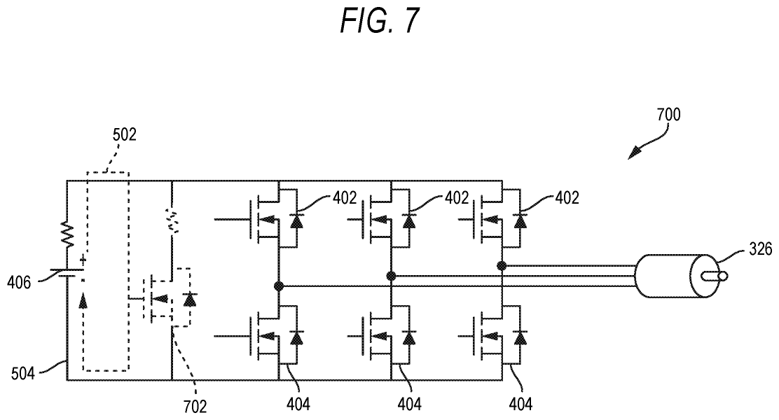

FIG. 7 is a circuit diagram 700 illustrating a current flow path through the switching network 324, according to some examples. In the example of FIG. 7, an additional switching element 702 is connected within the path of connection of the conductive path 504. Along with the additional switching element 702, an additional resistor is also connected to the path of connection of the conductive path 504.

For example, in response to detecting a pull of the trigger 108, the controller 302 may command the gate controller 322 to provide one or more control signals to selectively activate and deactivate the switching element 702, resulting in power being supplied from the power source 406. In this configuration, current 502 may flow from the power source 406 through the additional resistor and then through the additional switching element 702. In this example, the current 502 may travel only through the additional resistor and the additional switching element 702 before returning to the power source 406, thereby completing the circuit.

In various implementations, an inductor may be used in place of the additional resistor to achieve similar electrical characteristics. Additionally, other circuit configurations may incorporate alternative components, such as capacitors, depending on the specific application and design considerations.

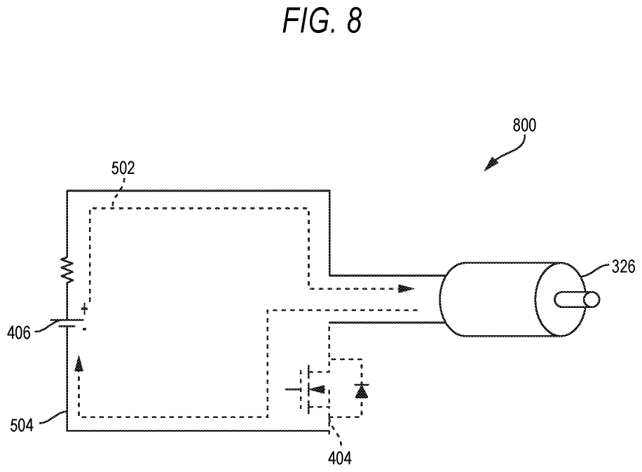

FIG. 8 is a circuit diagram 800 illustrating a current flow path through the switching network 324, according to some examples. In the example of FIG. 8, a single power switching element 404 is used. For example, in response to detecting a pull of the trigger 108, the controller 302 may command the gate controller 322 to provide one or more control signals to selectively activate and deactivate the power switching element 404, resulting in power being supplied from the power source 406.

In this configuration, current 502 may flow from the power source 406 to the motor 326 and then to the power switching element 404 before completing the circuit through the path of the connection formed by the conductive path 504. The specific current flow and switching sequence may vary depending on motor characteristics, control strategies, and application requirements.

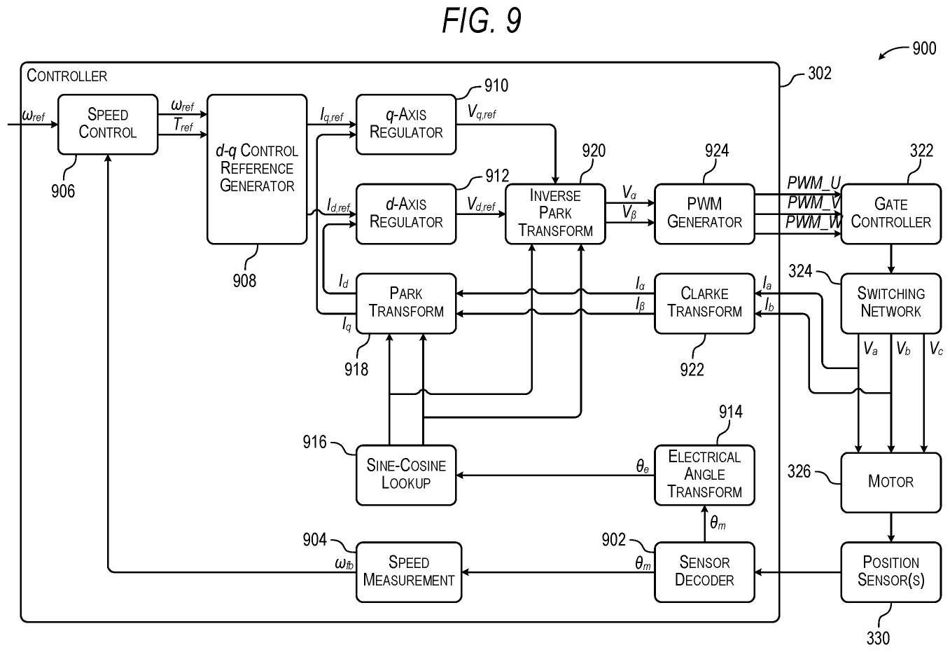

FIG. 9 is a block diagram 900 illustrating a topology for the controller 302 to implement field-oriented control, according to some examples. In the example of FIG. 9, to implement field-oriented control, the controller 302 receives position signals and current signals from the power tool 100 and generates corresponding pulse-width modulation (PWM) control signals for the gate controller 322. The position sensor 330 may detect the angular position of the rotor relative to the stator and output a position signal to a sensor decoder 902.

The sensor decoder 902 may generate a mechanical motor angle (θₘ) based on the position signal and output θₘ along with timing measurements to a speed measurement block 904. The speed measurement block 904 may calculate the rotor speed of the motor 326 and generate a motor speed signal (ω_{fb}) based on the mechanical motor angle (θₘ) and timing data. The motor speed signal (ω_{fb}) may then be sent to a speed control block 906.

The speed control block 906 may determine the difference between the motor speed feedback signal (ω_{fb}) and a reference speed (ω_{ref}). The reference speed (ω_{ref}) may correspond to a speed command received from the variable-speed trigger 108. Based on the speed difference, the speed control block 906 may generate a torque control signal (T_{ref}) and provide this signal to a d-q control reference generator 908.

In various implementations, the d-q control reference generator 908 may incorporate additional control strategies such as modulation index control, maximum-torque-per-ampere (MTPA) control, or field weakening control. This block may calculate d-axis and q-axis currents required to achieve the desired torque and speed. The d-axis represents the direct axis aligned with the rotor flux, while the q-axis represents the quadrature axis, which leads the d-axis by 90 electrical degrees and corresponds to the torque-producing component of the motor 326.

The d-q control reference generator 908 may generate a q-axis control current (I_{q,ref}) and a d-axis control current (I_{d,ref}) based on the torque control signal (T_{ref}) and the reference speed (ω_{ref}). These values may be determined by factors such as the desired speed, base speed of the motor, and control parameters. The q-axis control current (I_{q,ref}) may be provided to a q-axis regulator 910, while the d-axis control current (I_{d,ref}) may be provided to a d-axis regulator 912. Together, the speed control block 906, the d-q control reference generator 908, the q-axis regulator 910, and the d-axis regulator 912 may allow for independent torque-speed control of the motor 326, differing from other motor drive techniques, such as trapezoidal commutation or block commutation.

The sensor decoder 902 may also output the mechanical motor angle (θₘ) to an electrical angle transform block 914. This block may convert the mechanical rotor angle (θₘ) into an electrical rotor angle (θₑ), which is then provided to a sine-cosine lookup block 916. The sine-cosine lookup block 916 may compute the sine and cosine of the electrical rotor angle (θₑ) and output these values to both a Park transform block 918 and an inverse Park transform block 920.

In this example, the controller 302 receives two instantaneous line currents (Iₐ and I_{b}) from the switching network 324. In various implementations, a different set of line currents may be received. Two phases of the three-phase motor 326 may generate these line currents. A Clarke transform block 922 may convert the line currents (Iₐ and I_{b}) into α-β coordinate system currents (I_{α} and I_{β}). The α-β coordinate system provides a simplified two-phase representation of the three-phase motor 326. The Clarke transform block 922 may output the orthogonal currents (I_{α} and I_{β}) to the Park transform block 918.

The Park transform block 918 may receive the orthogonal line currents (I_{α} and I_{β}) along with the sine and cosine signals from the sine-cosine lookup block 916. Using these inputs, the Park transform block 918 may generate orthogonal d-axis and q-axis currents (I_{d} and I_{q}), which may represent the transformed phase currents in the rotating reference frame. The Park transform block 918 may output the q-axis current (I_{q}) to the q-axis regulator 910 and the d-axis current (I_{d}) to the d-axis regulator 912.

The q-axis regulator 910 may compute an error between the desired q-axis current and the actual q-axis current. The q-axis regulator 910 may receive the q-axis control current (I_{q,ref}) from the d-q control reference generator 908 and the q-axis current (I_{q}) from the Park transform block 918. Based on these inputs, the q-axis regulator 910 may compute a current error and apply a proportional-integral (PI) controller to generate a q-axis voltage control signal (V_{q,ref}). This signal may be provided to the inverse Park transform block 920.

Similarly, the d-axis regulator 912 may regulate the d-axis current. The d-axis regulator 912 may receive the d-axis control current (I_{d,ref}) from the d-q control reference generator 908 and the d-axis current (I_{d}) from the Park transform block 918. Using these inputs, the d-axis regulator 912 may compute a current error and apply a PI controller to generate a d-axis voltage control signal (V_{d,ref}). This signal may also be sent to the inverse Park transform block 920.

The inverse Park transform block 920 may convert the q-axis voltage control signal (V_{q,ref}) and the d-axis voltage control signal (V_{d,ref}) into simplified α-β orthogonal voltages (V_{α} and V_{β}). These voltages may then be sent to a PWM generator 924, which may generate PWM control signals based on the input voltages (V_{α} and V_{β}). The PWM generator 924 may output these PWM control signals to the gate controller 322.

The gate controller 322 may convert the PWM control signals into discrete control signals, such as, for example six separate voltage switching signals (PWM gate signals), used to drive the switching elements in the switching network 324. In some examples, the PWM signals operate at a frequency of at least 50 kHz. In various implementations, the PWM frequency may be lower than 250 kHz, depending on the control requirements and switching characteristics of the system.

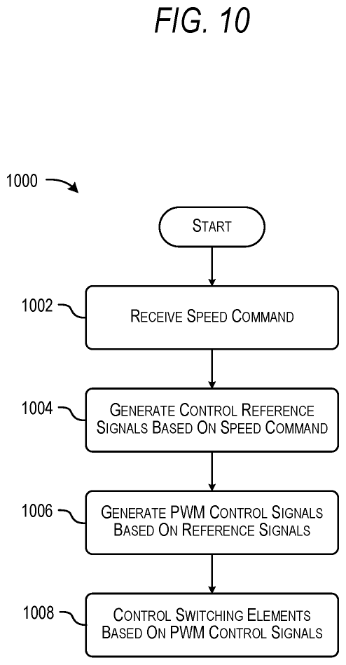

FIG. 10 is a flowchart illustrating a process 1000 for controlling the motor 326, according to some examples. Although the operations of process 1000 are illustrated with reference to specific examples, this process may be applied in different contexts to perform various motor control operations. The sequence of operations shown in FIG. 10 is presented in a particular order, but the operations may be reordered, executed in parallel, or repeated as appropriate for a given implementation.

In some examples, process 1000 may be executed by the controller 302 using the controller topology illustrated by the block diagram 900 to implement field-oriented control, as described with respect to FIG. 9. However, other implementations may use different configurations. In the example process 1000, the controller 302 receives a speed command (at block 1002). The speed command may be generated based on user input, such as from the variable-speed trigger 108 or another speed selection mechanism. In some examples, the controller 302 may determine the speed command based on operational parameters and power tool conditions. If the speed command is received from the trigger 108, a trigger switch may convert the degree of trigger actuation into a corresponding speed command, which can be provided to the controller 302 as a speed reference (ω_{ref}). In various implementations, the controller 302 may receive signals from the trigger 108 and generate the speed reference (ω_{ref}) based on those signals.

In the example process 1000, the controller 302 generates control reference signals based on the speed command (at block 1004). In various implementations, these control reference signals are associated with field-oriented control. With reference to FIG. 9, the speed control block 906 may receive the speed command and generate field-oriented control torque reference signals (T_{ref}) based on the received speed command. The speed control block 906 may also receive a motor speed measurement from the speed measurement block 904 and generate the field-oriented control torque reference signals to reduce the difference between the speed command and the measured motor speed. The d-q control reference generator 908 may then receive the field-oriented control torque reference signals and generate field-oriented control current reference signals (I_{q,ref} and I_{d,ref}). The d-q control reference generator 908 may determine these reference currents based on both the speed command and the field-oriented control torque reference signals.

In various implementations, the controller 302 may determine whether the speed command is greater than or equal to the base speed of the motor 326. The base speed of the motor may be defined as the maximum speed at which the motor operates while delivering its rated torque. If the speed command exceeds the base speed, the controller 302 may reduce the torque to maintain the commanded speed. The controller 302 may retrieve the base speed value from memory 306 and compare it with the speed command.

The method used to generate field-oriented control control reference signals may vary depending on whether the speed command is above or below the base speed of the motor 326. In some examples, the d-q control reference generator 908 may generate field-oriented control control reference signals using maximum-torque-per-ampere (MTPA) control when the speed command is below the base speed. When the speed command exceeds the base speed, the d-q control reference generator 908 may generate field-oriented control control reference signals using field weakening control to reduce torque while maintaining higher speeds.

In the example process 1000, the controller 302 generates PWM control signals based on the reference signals (at block 1006). The field-oriented control current reference signals may be sent to the q-axis regulator 910 and the d-axis regulator 912, which may calculate the error between the reference signals and the measured current flow between the switching network 324 and the motor 326. The PWM generator 924 may receive these error signals and generate PWM control signals accordingly. The PWM control signals may be adjusted to minimize the error, for example, by dynamically modifying the duty ratio of the PWM pulses based on the error magnitude.

In the example process 1000, the controller 302 may command the gate controller 322 to control the switching elements of the switching network 324 according to the PWM control signals (at block 1008), for example, according to any of the previously-described techniques. The switching elements may alternate between conducting and non-conducting states to regulate current flow between the power source and the motor 326. A PWM output from the controller 302 (or from the PWM generator 924) may be connected to an input of the gate controller 322. The gate controller 322 may receive the PWM control signals and translate them into gate drive signals for individual switching elements or switching element pairs, depending on the system configuration. These gate drive signals may then be applied to the switching elements.

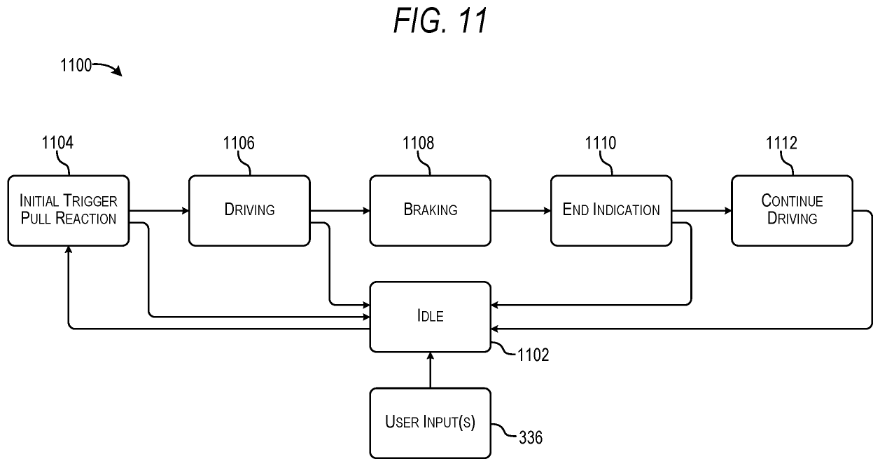

FIG. 11 is a state diagram 1100 illustrating various operational states of the power tool 100, according to some examples. Each block in FIG. 11 represents a distinct state that the power tool 100 may transition between based on user inputs, operating conditions, and control logic. Transitions between states may occur in response to factors such as trigger activation, torque threshold detection, battery pack status, and fault conditions. In various implementations, the controller 302 may monitor these inputs and execute state transitions to regulate motor operation, torque output, and other tool functions.

In the example state diagram 1100, the power tool 100 includes an idle state 1102, an initial trigger pull reaction state 1104, a driving state 1106, a braking state 1108, an end indication state 1110, and a continue driving state 1112. When the power tool 100 is powered on and initialized but not running (e.g., the controller 302 is not receiving commands from the user inputs 336), the power tool 100 may be in the idle state 1102. In the idle state 1102, the controller 302 is not commanding the motor 326 to operate (e.g., no quadrature-axis current [i_{q}] or direct-axis current [i_{d}] is commanded).

When the user actuates the trigger 108, the power tool 100 may transition from the idle state 1102 to the initial trigger pull reaction state 1104. In this state, the controller 302 may disable electronic clutch functionality for an initial time period following trigger actuation (e.g., approximately 5 to 50 milliseconds). In response to the trigger 108 remaining actuated beyond this initial time period, the power tool 100 may transition to the driving state 1106.

In the driving state 1106, the controller 302 operates the motor 326 according to user inputs, such as maintaining a desired rotational speed. In this state, the controller 302 may monitor signals from the sensors 328 and implement electronic clutch functionality based on these monitored signals.

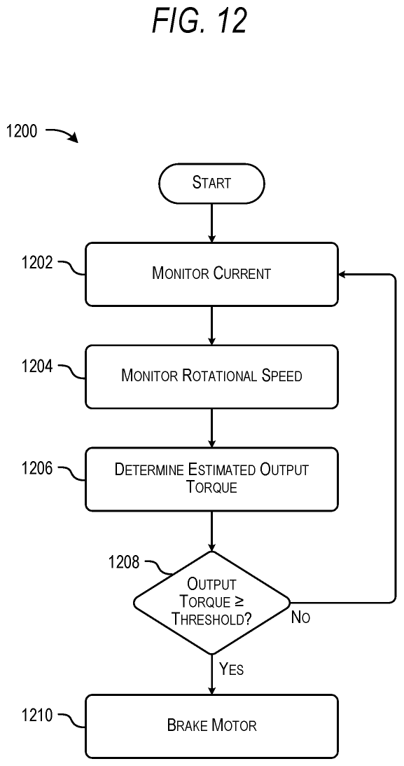

FIG. 12 is a flowchart of a process 1200 for implementing electronic clutch functionality, according to some examples. Although the operations of process 1200 are illustrated with reference to specific examples, this process may be applied in different contexts. The sequence of operations shown in FIG. 12 is presented in a particular order, but the operations may be reordered, executed in parallel, or repeated as appropriate for a given implementation.

In the example process 1200, the controller 302 monitors current components of the motor 326 (at block 1202). In implementations where the controller 302 uses field-oriented control, the controller 302 may determine the quadrature-axis current (i_{q}) and direct-axis current (i_{d}) based on signals from the current sensors 332. The current sensors 332 may measure phase currents at the motor 326, which may then be transformed into the d-q reference frame using a Clarke transform (to α-β coordinates) and a Park transform (to d-q coordinates). The direct-axis current (i_{d}) may correspond to magnetic flux, while the quadrature-axis current (i_{q}) may correspond to the torque-producing component.

In the example process 1200, the controller 302 monitors the rotational speed (w) of the motor 326 (at block 1204). The controller 302 may determine the motor speed based on signals from the position sensors 330. In various implementations, rotational speed (w) may be expressed in revolutions per minute (RPM), radians per second (rad/s), degrees per second (deg/s), Hertz (Hz), or revolutions per second (RPS).

Additionally or alternatively, the rotational speed of the motor 326 may also be estimated using signals from the current sensors 332 and/or the voltage sensors 334. For example, in implementations where sensorless estimation techniques are used, the electronic controller 302 may compute or infer rotor speed based on back EMF, which can be derived from voltage and current measurements. During operation, the controller 302 may monitor the voltage across the motor terminals using the voltage sensors 334 and the phase currents using the current sensors 332. By analyzing the relationship between terminal voltages, phase currents, and motor parameters (such as inductance and resistance), the controller 302 may estimate the back EMF generated by the motor 326. Since the amplitude and frequency of back EMF may be directly related to the rotational speed of the rotor, the controller 302 may use this information to estimate motor speed in real time or near-real time.

In the example process 1200, the controller 302 estimates output torque (at block 1206). The estimated output torque may approximate the torque at the output element 116 based on monitored current components and rotational speed. In various implementations, the controller 302 may compute the estimated output torque using a torque estimation model.

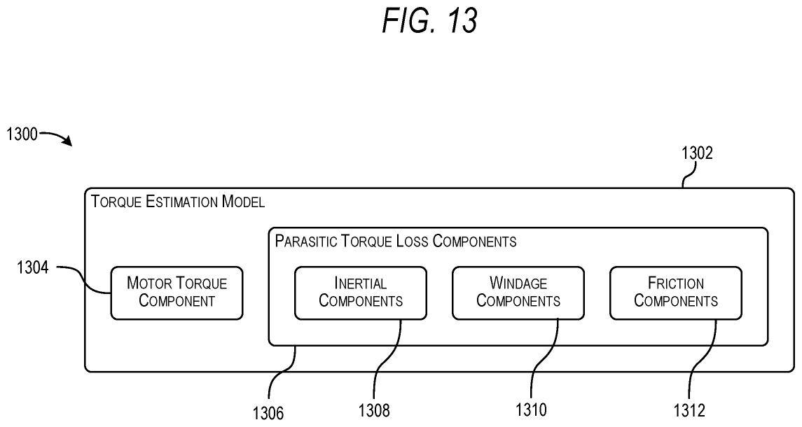

FIG. 13 is a block diagram 1300 illustrating components of a torque estimation model 1302, according to some examples. The torque estimation model 1302 includes a motor torque component 1304 and parasitic torque loss components 1306. The motor torque component 1304 represents an estimate of the torque output from the motor 326, while the parasitic loss components 1306 represent losses in torque transmission between the motor 326 and the output element 116. In various implementations, the parasitic loss components 1306 may include inertial components 1308, windage components 1310, and friction components 1312.

The motor torque component 1304 may be estimated based on the quadrature-axis current (i_{q}) and direct-axis current (i_{d}) at the motor 326, as computed by the controller 302 from the measured phase currents. In various implementations, when the motor 326 is a brushless DC motor (BLDC) or a surface permanent magnet synchronous motor (SPMSM), the controller 302 may estimate electromagnetic torque (Tₑ) using Equation (1):

$${T}_{e} = \frac{3}{2} {P}_{m} {λ}_{m} {i}_{q} \qquad ( 1 )$$

As illustrated by Equation (1), the controller 302 may estimate the electromagnetic torque (Tₑ) as a function of the number of pole pairs (Pₘ) of the motor 326, the permanent magnetic flux linkage (λₘ) of the motor 326, and the quadrature-axis current (i_{q}) at the motor 326.

For implementations where the motor 326 is an interior permanent magnet synchronous motor (IPMSM), the controller 302 may estimate torque using Equation (2):

$${T}_{e} = \frac{3}{2} {P}_{m} [ {λ}_{m} {i}_{q} + ( {L}_{d} - {L}_{q} ) {i}_{d} {i}_{q} ] \qquad ( 2 )$$

As illustrated by Equation (2), the controller 302 may estimate the electromagnetic torque (Tₑ) as a function of the number of pole pairs (Pₘ) of the motor 326, the permanent magnetic flux linkage (λₘ) of the motor 326, the quadrature-axis current (i_{q}) at the motor 326, the direct inductance (L_{d}) of the motor 326, the quadrature inductance (L_{g}) of the motor 326, and the direct-axis current (i_{q}) at the motor 326.

In other examples, the controller 302 uses other estimation techniques to estimate the output torque of the motor as a function of the quadrature-axis current (i_{q}) and/or the direct-axis current (i_{d}). In various implementations, the motor torque component 1304 may be represented as a value having units of Newton-meters (Nm).

The inertial components 1308 may represent the inertia of the motor 326 and/or the inertia of the drivetrain components between the motor 326 and the output element 116. In some examples, this may be relevant during startup. The controller 302 may compute the inertial components 1308 as a function of the rotational speed (ω) of the motor 326. In various implementations, the inertial components 1308 may be represented as a value with units of kilogram meters squared (kg·m²).

In some implementations, the inertial components 1308 may be estimated by analyzing the acceleration behavior of the motor 326 in response to an applied torque. For example, when a substantially constant torque is applied to the motor 326, a linear increase in rotational speed (e.g., in RPM) may be observed. The slope of this increase may correspond to angular acceleration (α), which can be used to infer the moment of inertia (J) of the system, for example, according to Equation (3) below:

$$T = J \cdot α \qquad ( 3 )$$

In Equation (3), T may represent applied torque (for example, in Nm), J may represent the moment of inertia (for example, in kg·m²), and a may represent the angular acceleration (for example, in rad/s²). By monitoring changes in motor speed over time under known torque components, the controller 302 may estimate the effective inertia of the system and update the inertial components 1308 accordingly.

The windage components 1310 may represent the torque losses associated with a fan at the motor 326. The controller 302 may compute the windage components 1310 as a function of the rotational speed (@) of the motor 326. In various implementations, the windage components 1310 may be represented as a value with units of Newton-meters (Nm). In some implementations, the controller 302 may estimate the windage components 1310 by evaluating steady-state operating conditions of the motor 326. For example, when the motor 326 operates at a constant speed (e.g., steady state), the applied motor torque may be balanced by the opposing load torque. Under no-load or low-load conditions, this opposing load torque may be primarily attributed to parasitic losses such as friction and windage. By operating the motor 326 at multiple steady-state speeds and recording the corresponding torque required to maintain each speed, the controller 302 may generate a model characterizing the relationship between rotational speed and windage/friction torque. This model may then be used to update the windage components 1310 and/or friction components 1312.

The friction components 1312 may account for torque losses due to friction between the motor 326 and the output element 116. The controller 302 may compute the friction components 1312 as a function of the rotational speed (ω) of the motor 326. In various implementations, the friction components 1312 may be represented as a value with units of Newton-meters (Nm).

The torque estimation model 1302 may determine the estimated output torque based on the motor torque component 1304 and the parasitic torque loss components 1306. In some examples, the controller 302 may subtract the parasitic torque loss components 1306 from the motor torque component 1304 to determine the estimated output torque.

In various implementations, the torque estimation model 1302 may be expressed according to Equation (3):

$${T}_{output} = f ( {i}_{q} , {i}_{d} ) - \frac{d ω}{dt} \cdot A - f ( ω ) \qquad ( 3 )$$

As illustrated by Equation (3), the estimated output torque (Tₒᵤₜₚᵤₜ) may be determined by subtracting dynamic losses

$$( \frac{d ω}{dt} \cdot A )$$

and speed-dependent losses f(ω) from the estimated motor torque f(i_{q},i_{d}). In various implementations, the dynamic losses

$$\frac{d ω}{dt} \cdot A$$

may include the inertial components 1308 and the speed-dependent losses f(ω) may include the windage components 1310 and/or the friction components 1312. In some embodiments, the estimated output torque is also compensated for temperature (e.g., motor temperature, switching circuit temperature, ambient temperature, etc.).

The controller 302 may apply a filter to process estimates of motor torque f(i_{q},i_{d}) and rotational speed (ω) to reduce noise and harmonics. In various implementations, the same type of filter with identical parameters may be applied to both estimates to maintain consistency and prevent discrepancies in signal timing.

If the estimates of motor torque f(i_{g},i_{d}) and rotational speed (ω\omegaω) are filtered differently, they may become misaligned. Filters can introduce phase shifts, which may cause signals to be delayed by different amounts depending on the filter characteristics. In some examples, applying different filters to the estimates of motor torque and rotational speed may lead to a time shift between the signals, introducing errors in the control system.

Additionally, the filters may be configured to have the same attenuation frequencies. Filters may attenuate different frequency components at varying rates. If the attenuation frequencies differ, certain harmonic components may be removed from one estimate but not the other, leading to inconsistencies that could affect system performance.

The attenuation frequency of the filter may be selected to mitigate aliasing caused by ripple in the torque and rotational speed signals. Aliasing may occur when high-frequency components are not sufficiently filtered before sampling, resulting in false low-frequency variations. This effect may arise if the sampling rate is too low to capture the full frequency content of the signal, leading to distorted or misleading data. In motor control applications, aliasing may introduce errors in torque estimation and cause unstable braking behavior. To reduce aliasing effects, the filter may be configured to remove high-frequency noise while preserving relevant signal information before sampling.

The attenuation frequency of the filter may also be set to reject the sixth harmonic frequency of the control system. In various implementations, the control system operates at approximately 1 kilohertz (kHz), so the filter may be configured to at least double the 6 kHz harmonic frequency. In some examples, the attenuation frequency is at least 12 kHz. In various implementations, the filter operates at approximately 20 kHz. In some examples, the filter is implemented as a second-order Butterworth filter.

Returning to FIG. 12, in the example process 1200, the controller 302 determines whether the estimated torque output meets or exceeds (e.g., crosses) a threshold (decision block 1208). In various implementations, the threshold is set based on user input, such as selections made via the torque selector 112 and/or range selector 114, as previously described. If the estimated torque output meets or exceeds the threshold (“YES” at decision block 1208), the controller 302 initiates braking of the motor 326 (block 1210). Otherwise (“NO” at decision block 1208), the controller 302 continues monitoring the current and rotational speed of the motor (returning to block 1202).

Referring collectively to FIGS. 11 and 12, the controller 302 may brake the motor by transitioning the power tool 100 into the braking state 1108. In the braking state 1108, the controller 302 may command various components of the power tool 100 to slow or stop the motor 326.

In various implementations, the controller 302 may command the gate controller 322 to turn on all low-side switching elements of the switching network 324. This configuration may create a low-impedance path for circulating current, dissipating energy through the stator windings and slowing the rotor. In some examples, the controller 302 may instead command the gate controller 322 to turn on all high-side switching elements, which may produce a similar braking effect with a different current decay profile.

In some implementations, braking may involve mechanical components. For example, the controller 302 may actuate a friction brake, which applies resistance to the motor shaft to slow rotation. In some examples, the controller 302 may engage a mechanical clutch, which decouples the drivetrain to isolate torque transfer. Additionally, in various implementations, an electromagnetic brake may be used, where the controller 302 energizes a braking coil to generate resistive force against the rotor.

The braking strategy may vary depending on factors such as the motor type, operational state, and desired stopping characteristics. In various implementations, the controller 302 may regulate braking intensity dynamically to balance stopping time, energy dissipation, and system stability.

After completing braking operations in the braking state 1108, the controller 302 transitions the power tool 100 to the end indication state 1110. In the end indication state 1110, the controller 302 may command various components of the power tool 100 to provide feedback indicating that the torque threshold has been reached and that the electronic clutch has interrupted torque transmission.

In various implementations, the controller 302 may generate motor twitching, where the motor 326 briefly oscillates or pulses in response to the braking event. This may provide a tactile indication to the user that the electronic clutch has engaged. In some examples, the controller 302 may activate one or more indicators 340 to communicate this status visually, audibly, or haptically. For instance, the controller 302 may illuminate an LED, generate an alert tone, or trigger a haptic vibration.

In the end indication state 1110, the power tool 100 may transition to the continue driving state 1112 if the controller 302 detects that the user continues holding the trigger 108 beyond a defined time threshold following the completion of braking operations in the braking state 1108. Otherwise, the power tool 100 transitions back to the idle state 1102.

In the continue driving state 1112, the controller 302 may intermittently apply torque to the output element 116 by briefly energizing the motor 326 in a pulsed manner. In various implementations, this may facilitate controlled incremental torque application, such as for driving a fastener in small increments. In some examples, this feature may help the user apply additional torque beyond the threshold previously set by the electronic clutch.

While in the continue driving state 1112, the controller 302 may suspend electronic clutch functionality to allow uninterrupted torque delivery. In response to detecting that the trigger 108 has been released, the controller 302 transitions the power tool 100 back to the idle state 1102.

Thus, embodiments described herein provide, among other things, a power tool implementing a field-oriented control electronic clutch. Various features and advantages are set forth in the following claims.

What is claimed is:

1. A power tool comprising:
an electric motor;
a first sensor configured to monitor an electrical property of the electric motor;
an electronic controller configured to:
determine at least one of a quadrature-axis current and a direct-axis current of the electric motor based on sensor signals from the first sensor,
determine a rotational speed of the electric motor,
determine an estimated torque output based on (i) at least one of the quadrature-axis current and the direct-axis current and (ii) the rotational speed, and
output, in response to the estimated torque output crossing a threshold, a command to brake the electric motor.

2. The power tool of claim 1, wherein the electronic controller is further configured to determine the estimated torque output according to a torque estimation model, the torque estimation model including a motor torque component and a parasitic loss component.

3. The power tool of claim 2, wherein the electronic controller is further configured to determine the estimated torque output by subtracting the parasitic loss component from the motor torque component.

4. The power tool of claim 2, wherein the electronic controller is further configured to determine an estimated motor torque based on the motor torque component, the motor torque component being a function of at least one of the quadrature-axis current and the direct-axis current.

5. The power tool of claim 2, wherein the electronic controller is further configured to:
determine the quadrature-axis current and the direct-axis current of the electric motor based on the sensor signals from the first sensor; and
determine an estimated motor torque based on the motor torque component, the motor torque component being a function of the quadrature-axis current and the direct-axis current.

6. The power tool of claim 2, wherein the electronic controller is further configured to determine an estimated parasitic torque loss based on the parasitic loss component, the parasitic loss component being a function of the rotational speed.

7. The power tool of claim 2, wherein the parasitic loss component includes at least one of an inertial component, a windage component, and a friction component.

8. The power tool of claim 1, wherein the electronic controller is further configured to determine the rotational speed of the electric motor based on sensor signals from the first sensor.

9. The power tool of claim 2, further comprising:
a second sensor configured to monitor a rotational characteristic of the electric motor; and
wherein an electronic controller is further configured to determine the rotational speed of the electric motor based on sensor signals from the second sensor.

10. A method comprising:
determining at least one of a quadrature-axis current and a direct-axis current of an electric motor of a power tool based on sensor signals from a first sensor, the first sensor being configured to monitor an electrical property of the electric motor;
determining a rotational speed of the electric motor;
determining an estimated torque output based on (i) at least one of the quadrature-axis current and the direct-axis current and (ii) the rotational speed; and
outputting, in response to the estimated torque output crossing a threshold, a command to brake the electric motor.

11. The method of claim 10, wherein the estimated torque output is determined according to a torque estimation model, the torque estimation model including a motor torque component and a parasitic loss component.

12. The method of claim 11, wherein determining the estimated torque output includes subtracting the parasitic loss component from the motor torque component.

13. The method of claim 11, further comprising:
determining an estimated motor torque based on the motor torque component, the motor torque component being a function of at least one of the quadrature-axis current and the direct-axis current.

14. The method of claim 11, further comprising:
determining the quadrature-axis current and the direct-axis current of the electric motor based on sensor signals from the first sensor; and
determining an estimated motor torque based on the motor torque component, the motor torque component being a function of the quadrature-axis current and the direct-axis current.

15. The method of claim 11, further comprising:
determining an estimated parasitic torque loss based on the parasitic loss component, the parasitic loss component being a function of the rotational speed.

16. The method of claim 11, wherein the parasitic loss component includes at least one of an inertial component, a windage component, and a friction component.

17. The method of claim 11, wherein the rotational speed of the electric motor is determined based on sensor signals from the first sensor.

18. The method of claim 11, wherein the rotational speed of the electric motor is determined based on sensor signals from a second sensor, the second sensor being configured to monitor a rotational characteristic of the electric motor.

19. A non-transitory computer-readable storage medium comprising executable instructions that, when executed by an electronic processor, causes the electronic processor to:
determine at least one of a quadrature-axis current and a direct-axis current of an electric motor of a power tool based on sensor signals from a first sensor, the first sensor being configured to monitor an electrical property of the electric motor;
determine a rotational speed of the electric motor;
determine an estimated torque output based on (i) at least one of the quadrature-axis current and the direct-axis current and (ii) the rotational speed; and
output, in response to the estimated torque output crossing a threshold, a command to brake the electric motor.

20. The non-transitory computer-readable storage medium of claim 19, wherein the executable instructions, when executed by the electronic processor, causes the electronic processor to:
determine the estimated torque output according to a torque estimation model, the torque estimation model including a motor torque component and a parasitic loss component.
